(19) United States
(12) Patent Application Publication
(10) Pub. No.: US 2009/0170940 A1
(43) Pub. Date: Jul. 2, 2009

(54) Modified ethyl formate compositions and methods for soil fumigation

(76) Inventors: Lilia Hernandez, Irapuato (MX); Ian Williams, Woodcliff Lake, NJ (US); John Williams, Hoboten, NJ (US); German Maya, Irapuato (MX)

Correspondence Address: Marc J. Farrell, Esq., Central PA Patent & Trademark Law Group, LLC, P.O. Box 2441, Harrisburg, PA, 17105-2441, US

(21) Appl. No.: 12/006,076

(22) Filed: Dec. 29, 2007

(51) Int. Cl. A01N 37/00; A01P 5/00

(52) U.S. Cl. 514/546

(57) ABSTRACT

Slow-flow, modified ethyl formate compositions and methods for their use as pre-plant soil fumigants (controlling nematodes and other pathogens) are provided. The modifications include adding to ethyl formate a viscosity modifying thickening agent, and one or more substances which function as a co-solvent and dilution agent (the co-solvent and dilution may or may not be the same). The thickening agent increases the viscosity thereby slowing its flow or rate of transport through the soil. The co-solvent functions as the primary solvent for the viscosity modifying thickening agent. The dilution agent does two things. First, it is used to reduce the partial vapor pressure of the ethyl formate in the formulation, thereby slowing its evaporation rate. Second, it also slows the rate and amount of decomposition of the ethyl formate. The SFMEF compositions and methods do not have harmful ozone-depleting side effects and break down into two naturally-occurring, environmentally-friendly components. Thus they are useful as replacements for methyl bromide and other known ozone-depleting and/or highly toxic soil fumigants.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR COMPUTER PROGRAM LISTING COMPACT DISC APPENDIX

Not Applicable

### BACKGROUND OF THE INVENTION

The present invention relates generally to soil fumigants and soil fumigation, and more specifically, to modified ethyl formate compositions and methods for their use as pre-plant soil fumigants.

Nematodes are tiny but complex animals that inhabit soil in great numbers. These unsegmented roundworms occur worldwide in all environments. Most species are saprophytes that live in compatible association with plants and other organisms. They are important members of the food chain and many are important contributors to decomposition of organic matter. Some, however, are parasitic on plants or animals. About 10 percent of the 20,000 nematode species currently identified are plant parasites. Plant-parasitic species cause an estimated annual crop loss valued at $8 billion in the U.S. and $78 billion worldwide.

Plant-parasitic nematodes puncture cells and feed by injection and extraction mechanisms. They damage plants mechanically and chemically (by introducing toxins or enzymes) and predispose plants to other pathogens by providing points of entry. Ectoparasitic nematodes feed from the plant surface. Endoparasitic nematodes feed within and between cells. Some species have both ecto- and endoparasitic feeding habits. Most nematodes penetrate root cells by means of a sharp, hollow stylet. A few genera penetrate cells using a grooved “tooth.” Species that are not parasitic on plants do not have a stylet or tooth.

Nematode feeding reduces plant vigor and induces lesions, rots, deformations, galls and root knots. The stress of nematode infections lowers the general disease resistance of host plants. Root disorders caused by parasitic nematodes are difficult to diagnose and often are unnoticed or are attributed to other causes such as drought, nutrient deficiency, or root rots caused by fungal pathogens such as Pythium or Rhizoctonia. Affected crops appear uneven, usually with patches of stunted, yellow plants. Symptoms are likely to be most evident during or following periods of hot weather, drought, low fertility, and other stresses.

One known method of controlling pests and the like generally is fumigation. Fumigation involves completely filling an area with gaseous pesticides to suffocate or poison the pests within. It is utilized for space fumigation, which includes both structural fumigation (control of pests in buildings) and commodity or storage fumigation (i.e., fumigating portable items without having to invest in expensive tarps and seals needed to “tent” an entire building). It is also utilized for fumigation of soil prior to a crop being planted.

In structural fumigation, living organisms (such as termites) that can cause damage to buildings and other structures are targeted and killed. Commodity or storage fumigation is designed to kill living organisms on food and other products, in packaging materials either at the point of export or import (to prevent transfer of exotic organisms, for example), or during storage of agricultural products or other commodities. It is typically conducted under tarpaulins, in shipping containers, truck trailers, warehouses, and in chambers specifically designed for fumigation, and includes treatment of post-harvest food products such as grain, fruits, nuts and the like. By contrast, the goal of soil fumigation is to kill all (or particular) living organisms in soil prior to the planting of certain crops. The chemical is injected into soil, which is then covered by a plastic tarp to contain the fumigant until the organisms are killed.

Chemical products used to control nematodes have generally fallen into two major classes, fumigants and non-fumigants or “contact” nematicides, based on their chemical and physical characteristics. The first economically effective nematicides were soil fumigants. These are chemicals that, when applied to soil, generate fumes that spread through the soil pores to treat a volume of soil reasonably uniformly. Their key characteristic is that they are locally redistributed in the soil by diffusion as gases. Some are economically effective against several kinds of pests (among nematodes, fungi, bacteria, insects and weeds), and are thus often called “multi-purpose” or “broad-spectrum” fumigants. Others that have been used primarily for nematode control, lacking significant effects against any other important pest group, are the fumigant nematicides.

Soil fumigation kills most weed seeds, plant pathogens, nematodes, and insects in the soil. Fumigants may be applied as granular or liquid formulations. Upon injection into the soil as liquids, true fumigants—because they are volatile substances—change into gases. Other pesticides used in a similar manner may remain mixed with “soil water.”

Fumigants move through “soil air,” dissolve in the soil water and kill in the soil water. The vapors can only move through the continuous soil air space. They dissolve in the soil water and establish a dynamic equilibrium between the soil air and the soil water. Fumigant gas molecules then are moving back and forth from the air to the water phase as the fumigant diffuses through the soil mass. That portion of the fumigant dissolved in the soil water establishes the concentrations responsible for the kill of the soil-borne organisms. Insects which live in the soil air are killed by fumigant concentrations in the soil air. Dose equals fumigant concentration multiplied by the duration of exposure. The objective in soil fumigation is to establish a lethal concentration and maintain that concentration for a sufficient period of time to kill the target organisms throughout the soil, while using the minimum amount of soil fumigant necessary.

Of all the pesticides, soil fumigants are potentially the most volatile because of their high vapor pressures. Volatilization of a fumigant from soil is controlled by its rate of transport and degradation in soil. The transport of fumigants in soil is very rapid because it is dominated by gas-phase diffusion. The rapid transport is evident in that most emission loss occurs shortly after fumigation. In contrast to the rapid transport, the degradation of most fumigants is relatively slow, with half-lives ranging from days to weeks.

Thus, when using soil fumigation, considerations include, but are not limited to, the following: target pests (rates vary for different target pests—in general, nematodes and soil insects are killed at lower rates than weed seeds and fungal or bacterial pathogens); soil texture (as the microscopic spaces between soil particles get smaller and less abundant, fumigant rates must be increased to overcome reduced or slower diffusion and penetration); soil temperature (typically, for effective fumigation, soil temperature at a depth of six inches must be at least 50° F.—higher soil temperatures favor greater volatilization of fumigants and greater movement through soil spaces); soil organic matter (decomposed organic matter improves soil structure and generally helps fumigant dispersion in the soil); and soil moisture (fumigants move in soil water and must enter the soil solution to contact and kill pests—moderate levels of soil moisture therefore aid in obtaining effective fumigation).

Methyl bromide (CH₃Br), also known as bromomethane, is an effective herbicide, nematicide, insecticide, and fungicide. It was used commercially in the U.S. for soil fumigation and quarantine purposes for most of the 20th century (and continues to be used today, albeit on a much smaller, more controlled, and dwindling scale). Methyl bromide is sold as a liquid under pressure. Upon release, it vaporizes to form a gas that is about 3.3 times heavier than air.

By the 1990's, methyl bromide had become a widely used fumigant in U.S. agriculture and was one of the five most used pesticides in the U.S., with between 25 and 27,000 metric tons of methyl bromide being applied annually. More than 75% of that methyl bromide use was for pre-plant fumigation of soil. In addition, methyl bromide was used for post-harvest treatment of non-perishables (13%) and perishables (8.6%) and for quarantine purposes (<1%). For many years, methyl bromide was accepted as the fumigant of choice when planting crops such as strawberries and tomatoes.

When used as a soil fumigant, methyl bromide gas is usually injected into the soil at a depth of 12 to 24 inches before a crop is planted. This effectively sterilizes the soil, killing the vast majority of soil organisms. Immediately after the methyl bromide is injected, the soil is covered with plastic tarps, which slow the movement of methyl bromide from the soil to the atmosphere. Additional methyl bromide is emitted to the atmosphere at the end of the fumigation when the tarps are removed. When an entire field is fumigated, the tarps are removed 24 to 72 hours later (as can be the case in, for example, strawberry production in California). However, with row (or bed) fumigation (as is the case, for example, with tomato production in Florida), the tarps are left on for the entire growing season, some 60 to 120 days. About 50 to 95% of the methyl bromide injected in to the soil can eventually enter the atmosphere. In the United States, strawberries and tomatoes are the crops which have used the most methyl bromide. Other crops which use this pesticide as a soil fumigant include but are not limited to tobacco, peppers, grapes, and nut and vine crops.

When used as a commodity treatment, methyl bromide gas is injected into a chamber or under a tarp containing the commodities. A high proportion of the methyl bromide used for a typical commodity treatment eventually enters the atmosphere. Commodities which use this material as part of a post-harvest pest control regime include grapes, raisins, cherries, nuts and imported materials. Some commodities are treated multiple times during both storage and shipment. Commodities may be treated with methyl bromide as part of a quarantine or phytosanitary requirement of an importing country. A structural pest control treatment with methyl bromide gas involves the fumigation of buildings for termites, warehouses and food processing facilities for insects and rodents, and ships (as well as other transportation vehicles) for various pests.

The use of methyl bromide as a soil fumigant was a critical factor in dramatic changes in crop production systems in California, Florida, North Carolina and elsewhere. Before widespread use of soil fumigation and plastic mulching, crop rotations were the standard methods of pest management. With the move away from crop rotations, production of crops such as strawberries and fresh market tomatoes became highly dependent on methyl bromide use, which in turn led to further reductions in crop rotations and reductions in diversification in production practices.

Considerable evidence began to be accumulated demonstrating that methyl bromide was a potent ozone depletory. The Montreal Protocol on Substances That Deplete the Ozone Layer (“Montreal Protocol”) is an international treaty designed to protect the ozone layer by phasing out the production of a number of substances believed to be responsible for ozone depletion, including methyl bromide. The treaty was opened for signature on Sep. 16, 1987, was entered into force on Jan. 1, 1989, and underwent seven revisions between 1990 and 1999. In October 1998, the U.S. Congress attached an amendment to the Fiscal Year 1999 Appropriations bill which made specific changes to the Clean Air Act. The amendment required the federal Environmental Protection Agency (“EPA”) to make regulatory changes to the U.S. phase-out of methyl bromide, in order to essentially “harmonize” the U.S. phase-out of methyl bromide with the Montreal Protocol phase-out schedule for developed countries.

As a result, under the Montreal Protocol and the Clean Air Act, phase out of the use of methyl bromide in the U.S. began. The loss of use of methyl bromide and lack of an alternative fumigant created a situation in which the economic viability of specific crops in Florida, California, North Carolina and other states was and continues to be jeopardized.

While the Montreal Protocol and the Clean Air Act have severely restricted the use of methyl bromide internationally, the United States has successfully pushed for critical-use exemptions of the chemical. For example, in 2004 over 7 million pounds of methyl bromide were applied to California fields, according to pesticide use statistics compiled by the California Department of Pesticide Regulation. Nevertheless, the move towards elimination of methyl bromide use in the U.S. has stimulated a great deal of research aimed at improving the ability to manage soil-borne pathogens using ecologically-based pest management strategies. Thus far no generally accepted, high-performance replacement for methyl bromide has been found, particularly for a strawberry and tomato fumigant.

Aside from methyl bromide, the other commercially-available/approved soil fumigants have been: (a) 1-3 dichloropropene (brand names, Telone®, InLine®); (b) chloropicrin (marketed as liquids under the names Chlor-O-Pic®, Larvacide 100™ and Quasar™); (c) sodium tetrathiocarbonate (brand name, Enzone®), which produces carbon disulfide gas; (d) metam-sodium (sold under a variety of brand names, including Vapam®, Sectagon® and Sanafoam®); (e) dazomet (Basamid®), also known as tetrahydro-3,5-dimethyl-2H-1,3,5-thiadiazine-2-thione; and (f) metam-potassium (K-Pam®), also known as potassium N-methyldithiocarbamate.

The latter three compounds above (metam-sodium, dazoment, and metam-potassium) each accomplish fumigation via the production of methyl isothiocyanate (MITC). MITC is a general biocide used to control weeds, nematodes, and soil and wood fungi. On contact with warm, moist soil, metam-sodium, dazomet, and metam-potassium decompose quickly to MITC and other volatile gases, which diffuse upward through the spaces in the soil. It is MITC that performs the fumigating activity of these three soil sterilants.

Metam sodium in particular has seen an increase in use in recent years as a replacement for methyl bromide. As of 2006, metam sodium was the most widely used soil fumigant, and the third most widely used pesticide in U.S. agriculture. Metam sodium acts as a fungicide, herbicide, insecticide, and nematicide simultaneously. Half of its use is in potato production, and 90% percent of its use is in Idaho, Washington, Oregon and California. However, both the U.S. EPA and the California EPA classify metam sodium as a carcinogen.

As of October 2007, the EPA was in the midst of assessing risks and developing risk management decisions for several of the above-mentioned soil fumigant pesticides, including metam sodium, chloropicrin, dazomet and methyl bromide (as well as a new active ingredient, iodomethane).

As is apparent, the known, commercially-available soil fumigants continue to come under heavy environmental scrutiny and have experienced (or are facing the possibility of) severe restrictions on the nature and extent of their use. Nevertheless, the fact remains that the successful growth of a wide variety of crops is directly dependent on the use of some type of soil fumigant. In particular, strawberries and tomatoes are two of the crops with the most intensive use of soil fumigants because they are particularly vulnerable to several types of pathogens, insects, nematodes and mites that conventional farmers largely control with fumigants. These crops have also traditionally used the greatest amount of methyl bromide. In California alone in 2003, 3.7 million pounds of methyl bromide and 3.3 million pounds of chloropicrin were used to fumigate strawberry fields, and 2.8 million pounds of metam sodium were used on tomatoes.

U.S. Pat. Nos. 4,226,859 and 4,256,741, both to Stach, relate to pyridyl esters of N-alkylidene-substituted phosphor- and phosphonamidic acids, and disclose chemical compounds (and insecticidal compositions utilizing the compounds) of the formula:

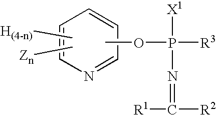

wherein X¹ is selected from the group consisting of oxygen and sulfur; R¹ is selected from the group consisting of hydrogen, alkyl, phenyl, alkoxy and alkylthio; R² is selected from the group consisting of alkoxy, alkylthio, amino, alkylamino and dialkylamino; with the proviso that a maximum of one of R¹ and R² is alkoxy or alkylthio; Z is selected from the group consisting of alkyl, alkoxy, nitro and halogen; and n is an integer from 0 to 4; and wherein R³ is selected from the group consisting of alkyl, alkoxy, alkylthio and

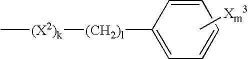

wherein X² is selected from the group consisting of oxygen and sulfur; X³ is halogen; k is the integer 0 or 1; and l and m are each integers from 0 to 3.

U.S. Pat. No. 4,683,224 to Fahmy relates to N-formyl phosphonamidothioates as pesticides, and discloses compounds of the formula:

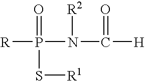

wherein R is alkyl or alkenyl of up to six carbon atoms, phenyl or benzyl; R¹ is straight-chain alkyl of three to five carbon atoms, branched-chain alkyl of three to six carbon atoms, phenyl or benzyl; and R² is hydrogen, alkyl, alkenyl or alkynyl of up to six carbon atoms, or alkyl of one to six carbon atoms substituted by phenyl; phenyl or phenyl substituted by one to three substituents selected from alkyl of one to six carbon atoms and halogen. The compounds are said to be useful as insecticides, miticides and/or nematicides.

U.S. Pat. Nos. 5,192,357, 5,304,530, 5,332,752 and 5,510,344, all to Cliff et al., relate to acrylate fungicides, and disclose compounds of the formulae:

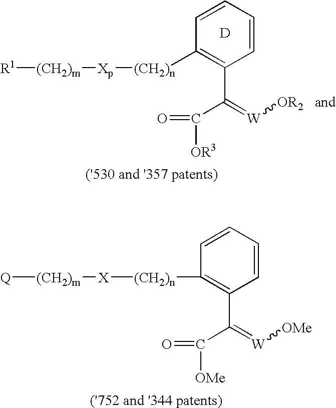

wherein Q, X, W, D, R¹, R², R³, x, m, n and p are as defined in the respective descriptions. The compounds are said to have pesticidal/fungicidal activity.

U.S. Pat. Nos. 5,380,883 and 5,451,696, both to Benoit et al., relate to 7-ethylene-α-(methoxymethylene)-1-naphthalene acetic acid and 7-ethynyl-α-(methoxymethylene)-1-naphthalene acetic acid, respectively, and disclose compounds of the formulae:

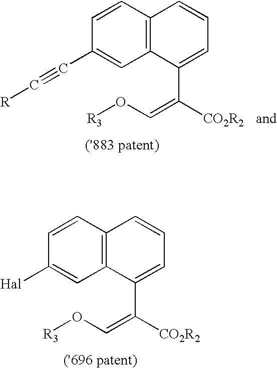

The compounds are said to be parasitic compositions for use in combating parasites.

U.S. Pat. Nos. 5,874,097 and 6,352,703, both to Henderson et al., relate to compositions and methods for detecting and killing termites, and disclose the so-called discovery of several components of termite nest cartons, which according to Henderson et al. were previously unknown. The compounds are said to be useful as an attractant for termite baits, as a feeding stimulant, as the basis for chemical methods of detecting termite nests, and as the basis for biological methods of controlling termites.

U.S. Pat. No. 6,203,824 to Banks et al. relates to carbonyl sulphide, which Banks et al. assert had up until that point not been known as a fumigant for the control of insects and mites. Banks et al. further disclose that when used as a fumigant, carbonyl sulphide exhibited fumigation properties comparable to those of phosphine and methyl bromide. Banks et al. disclose the use of carbonyl sulphide as a fumigant for stored grain and other stored produce (including perishable foodstuff), soil, timber and spaces (such as buildings).

U.S. Pat. No. 6,294,545 to Urch et al. relates to bicyclic amines and their use as insecticides, and discloses a compound of the formula:

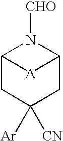

wherein A is a bidentate group of the formula: XC═CY or XCH—CHY (wherein X and Y are independently hydrogen, hydroxy, acyloxy, alkoxy, cyano or halogen); and Ar is optionally substituted phenyl or optionally substituted heteroaryl; or an acid addition salt, quaternary ammonium salt or N-oxide derived therefrom; provided that when A is CH₂—H₂ then Ar is neither 5-chloropyrid-3-yl nor 5-trifluoromethylpyrid-3-yl.

None of the above-noted references disclose the use of ethyl formate as a soil fumigant. Moreover, ethyl formate is a simple ester compound, unlike the compounds disclosed in the above-noted patents. It is chemically quite different from the pyridyl esters (pyridine derivatives) of Stach ('859 and '741), the N-formylphosphoamide-thioates of Fahmy ('224), the acrylate fungicides of Cliff et al. ('357, '530, '752 and '344), the complex acetic acid compounds of Benoit et al. ('883 and '696), the termite-killing compounds (primarily phenols and naphthalene) of Henderson et al. ('097 and '703), the carbonyl sulfide insecticides (for use as a storage/space fumigant, not for soil fumigation) of Banks et al. ('824), and the bicyclic amines of Urch et al. ('545).

While ethyl formate has been known as a suitable space fumigant for silos or storage spaces for wheat, grain and dried fruit in some parts of the world (such as South Africa and Australia) killing mainly thrips, moths and the like, heretofore there has been no prior use or disclosure of ethyl formate as a soil fumigant.

The fact that one compound may be effective as a space/storage or commodity fumigant does not necessarily mean it will serve as an effective soil fumigant, and vice versa. For example, metam sodium is effective as a soil fumigant yet, because of its low vapor pressure it would not be effective as a space fumigant. In addition, metam sodium decomposes to MITC, which cannot come into contact with grains or other stored food products.

The converse is generally also true with regard to the ability of space/storage and commodity fumigants to serve as effective soil fumigants. The most frequently used space/storage fumigants include (or have recently included prior to phasing out) methyl bromide, chloropicrin, aluminum phosphide, magnesium phosphide, hydrogen cyanide, and sulfuryl fluoride. Of those, the only two that have been used for both soil and space fumigation are methyl bromide and chloropicrin. The remaining available space fumigants cannot, for one reason or another, be used as suitable soil fumigants (and likewise, the available soil fumigants—other than methyl bromide and chloropicrin—cannot be used or do not perform satisfactorily as space fumigants).

Even though methyl bromide and chloropicrin have been shown to be chemically suitable as fumigants in both a soil and a commodity/storage environment, they each have significant other shortcomings that make them problematic to use (not the least of which is sheer unavailability, owing to the reductions and phase-outs mandated or soon to be mandated by various international treaties and national environmental laws and regulations). For example, because methyl bromide is a colorless, odorless and tasteless gas, it is difficult to detect using one's own senses. This makes methyl bromide particularly dangerous because it is highly toxic as a respiratory poison and can cause serious eye and skin damage. Likewise, chloropicrin—while not only being highly toxic to insects, vertebrates, and many soil microbes such as fungi—is also highly irritating to eyes and is a powerful “tear gas.” Concentrations as low as 1.0 parts per million (ppm) cause intense eye irritation, and prolonged exposures cause severe lung injury. Chloropicrin can cause severe injury upon skin contact.

The remaining approved storage/commodity fumigants (aluminum phosphide, magnesium phosphide, sulphuryl fluoride, and carbon dioxide)—either owing to their chemical make-up, their volatility and extreme toxicity to humans and other animals, or some other factor—are such that they simply could not be applied to soil in a pre-plant fumigation scenario. Fumigation conducted in a fixed or totally sealed chamber, as is the case with space/storage fumigation, presents a much different set of logistical and other issues that make the two treatments quite unalike.

For example, aluminum phosphide (products marketed under the trade names Detia®, Fumitoxin®, Gastoxin®, Phostek™ and Phostoxin®) is commonly used to fumigate grain-storage facilities. It reacts with atmospheric water to produce hydrogenphosphide (phosphine), a colorless gas. Likewise, magnesium phosphate, which is used effectively for warehouse and processing-plant fumigations, releases phosphine gas in reaction with water (the release of gas occurring even faster than occurs with aluminum phosphide). Phosphine gas is highly toxic to all forms of animal life and thus both compounds are inappropriate for use as soil fumigants.

Sulphuryl fluoride, sold under the trade name Vikane®, is a colorless, odorless gas. It too is highly toxic to humans and therefore not suitable for use as a pre-plant soil fumigant. Hydrogen cyanide is used as a fumigant in dwellings, warehouses, and ships, mainly to kill rats and other vermin. It is a colorless, volatile, and extremely poisonous flammable liquid. producing potentially lethal concentrations at room temperature.

Thus, as the above demonstrates, and as one skilled in the art would appreciate, the fact that one compound may be an effective space/commodity fumigant is not indicative of whether or not it would also be effective as a soil fumigant (and vice versa). While both scenarios have as their goal “fumigation” in a broad sense, the circumstances surrounding each (modes of treatment, method of operation, environment, safety precautions, criteria to be used in selecting a suitable fumigant, and the like) are quite different. In fact, fumigation for the control of insects above the ground is looked upon as an entirely separate field of endeavor from soil fumigation. This is particularly true with regard to nematodes, since control of nematodes is mainly an aspect of soil fumigation.

Millions of dollars and hundreds of thousands of man-hours continue to be devoted towards research programs aimed at finding alternatives to methyl bromide, and on efforts to minimize use and emissions of methyl bromide. By way of example, one very recent effort to roll out a methyl bromide replacement has stirred up substantial controversy and been met with formidable resistance on a number of fronts. The EPA registered methyl iodide on Oct. 5, 2007. The State of California entered methyl iodide into its evaluation process on Aug. 22, 2007. The registrations of methyl iodide (also known as iodomethane) are as a new chemical touted as a replacement for methyl bromide for soil fumigant applications. EPA registered methyl iodide despite a concerted effort resulting in a Sep. 25, 2007 letter from dozens of distinguished chemists saying that it is “astonishing” that the EPA is considering “broadcast releases of one of the more toxic chemicals used in manufacturing into the environment.” Although EPA announced it would “address recent questions prompted by the pending registration of iodomethane,” it went ahead with the registration a few days later. However, it took the unusual step of registering methyl iodide for only one year. Various groups believe this provides some hope for a reversal of the decision to register methyl iodide. These groups assert that, despite the fact that methyl iodide is not an ozone-depleting substance (although chemically related to methyl bromide, methyl iodide is much more reactive—it reacts with air and water before it can be transported to the stratospheric ozone layer), there are still a number of other reasons why EPA should have refused the registration of this chemical.

Thus a need exists for a generally accepted, high performance soil fumigant to replace methyl bromide, particularly for a strawberry and tomato fumigant.

The need also exists for methods of managing soil-borne pathogens using ecologically-based pest management strategies.

The need also exists for a fumigant which retains the effective fumigation properties exhibited by ethyl formate when ethyl formate is used for space/storage fumigation, and yet which can be applied to soil in the form of a biodegradable mixture having minimal impact on the environment.

The need also exists for a soil fumigant which combines the greater soil penetration of methyl bromide with the higher toxicity of other known soil fumigants such as chloropicrin, while at the same time avoiding the significant negative impact that methyl bromide and chloropicrin have on the environment.

The need also exists for an ethyl formate-based soil fumigant which is modified by the addition of various other chemicals and compounds to improve various characteristics—such as a reduction in partial pressure to slow the evaporation rate, and to slow ethyl formate's rate of decomposition—thereby making the modified ethyl formate composition more effective when as a soil fumigant than would be the case if “pure” ethyl formate was used.

### BRIEF SUMMARY OF THE INVENTION

The inventors of the present invention found, surprisingly, that by making certain modifications to ethyl formate, it could in fact be used as an extremely effective soil/field fumigant having many positive benefits and few if any negative effects. A viscosity thickening agent, a co-solvent, and a dilution agent (which may be the same as the co-solvent) are added to ethyl formate, providing a slow-flow, modified ethyl formate composition (referred to hereinafter at times as “SFMEF” for short) which can be used for soil fumigation (controlling nematodes and other pathogens).

Pre-plant fumigation with the SFMEF of the present invention can be used in conjunction with the production of many fruits and vegetables, including but not limited to strawberries, tomatoes, peppers and other similar products.

Ethyl formate does not react with ozone and therefore, unlike methyl bromide, does not contribute to the depletion and destruction of the ozone layer. Ethyl formate also has the added advantage of degrading to two non-poisonous, environmentally-friendly and naturally-occurring products (formic acid and ethanol).

### BRIEF DESCRIPTION OF THE SEVERAL VIEWS OF THE DRAWINGS

For the present invention and its presently preferred embodiments to be clearly understood and readily practiced, the present invention will be described by way of reference to the detailed disclosure hereinbelow in conjunction with the following figure(s), wherein like reference characters designate the same or similar elements, which figure(s) is/are incorporated into and constitute a part of the specification, wherein:

FIG. 1 is a graph of an illustrative embodiment of the composition and method of the present invention, showing the viscosity for a mixture of about 70 percent by weight ethyl formate and about 30 percent by weight ethanol, to which 0.0, 0.5 and 0.10 percent by weight of a thickening agent was added.

FIG. 2 is a graph showing the relative evaporation rates of three samples, and the reduction in evaporation rate that occurs as a result of the addition of ethanol and a thickening agent.

### DETAILED DESCRIPTION OF THE INVENTION

The disclosure now turns to a discussion of various details that may be incorporated in accordance with at least one presently preferred embodiment of the present invention. The details discussed hereinbelow are meant to be illustrative instead of restrictive, and it thus should be understood that there remain a very wide variety of possible implementations for SFMEF compositions and methods within the spirit and scope of the present invention.

In its commercial form, ethyl formate (C₃H₆O₂), also known as ethyl methanoate, has the following properties at a temperature of 20° C.:

| | |
|---|---|
| Density: | 0.923 g/cm³ |
| Viscosity: | 0.396 centipoise |
| Vapor Pressure: | 0.277 kgf/cm²a |

Ethyl formate is a colorless liquid with a low boiling point (54.1° C.) and a pleasant aromatic odor. It occurs naturally in soil, the ocean, vegetation and a range of food products, including vegetables, fruit, grain, beer and animal products such as milk and cheese.

Ethyl formate does not contain any hazardous air pollutants as defined under the Clean Air Act, nor does it contain any Class 1 or Class 2 ozone depletors. None of the chemicals in commercially-available ethyl formate (98+%) are listed as “Hazardous Substances,” “Priority Pollutants” or “Toxic Pollutants” under the Clean Water Act, nor are any of its constituents considered highly hazardous by OSHA.

Ethyl formate has been used as a storage/space/commodity fumigant for harvested crops in packages, containers and silos. By contrast, pure ethyl formate would be relatively ineffective as a soil fumigant. While capable of killing nematodes in, for example, a laboratory setting (petri dish), its viscosity is such that the rate of transport or flow through the soil would be too rapid, and its vapor pressure is such that it would be prone to quick evaporation—viscosity and evaporation rate being two properties which are particularly important as they relate to a soil fumigant's ability to kill not just the nematodes but also all (or nearly all) of the nematodes' eggs. Thus, there has been no interest in (let alone any actual prior use of) pure ethyl formate as a soil fumigant. However, the inventors of the present invention have found, surprisingly, that ethyl formate can in fact be used as a soil fumigant—and a very effective one at that—by modifying certain of its properties.

In the present invention, ethyl formate is used as an effective soil/field fumigant for crops such as strawberries and tomatoes. This is achieved by adding to ethyl formate a thickening agent, a co-solvent, and a dilution agent (which may be the same as the co-solvent). one or more substances capable of sufficiently dissolving the thickening agent (performing a co-solvent function) and sufficiently diluting the composition (functioning as a dilution agent).

Ethyl formate, with a viscosity of 0.396 centipoise, is a thin liquid and is in fact much less viscous than water. Thus, for ethyl formate to be effective as a soil fumigant, its viscosity must be increased so as to reduce its rate of permeation into and through the soil as a liquid. Pursuant to the present invention, a suitable thickening agent is added to increase viscosity and advantageously invoke a slow spread and flow of the ethyl formate. This addition of a viscosity modifying thickening agent reduces the fumigant's penetration rate into the soil, and achieves a more uniform degree of wetting throughout the soil layer along with a longer contact time. Effectively, the SFMEF compositions and methods of the present invention utilize the flow of vapor and liquid molecules over and throughout the soil which eventually will dissolve into the water contained in the soil.

Any suitable viscosity modifier may be used as the thickening agent. Typically, viscosity modifiers are compounds which are soluble in the primary liquid of the formulation, which cause increased viscosity and which, after addition, cause the mixture to behave in a non-Newtonian way. By way of example, and in no way intending to be limiting, thixotropic polymers may be used as for the viscosity modifying thickening agent of the present invention. One specific example of a suitable thickening agent is a product sold by Lubrizol Corp. under the tradename Carbopol® ETD 2623.

The amount of polymer added can be about 0.01% by weight or greater. The viscosity modifying thickening agent used in the present invention will be used in an amount sufficient to give the required viscosity characteristics. Preferably, the amount of thickening agent must be such that when added to ethyl formate the resulting SFMEF composition of the present invention has a viscosity of between about 1 and about 250 centipoise, and more preferably between about 100 and about 250 centipoise. By way of illustration, the amount of thickening agent added can be about 0.01% by weight or greater. In the case of certain polymer thickening agents, a few drops of a neutralizing agent, such as triethylamine, may be necessary in order to activate the polymer. Depending upon the thickening agent chosen, activation may not be required and thus the addition of a neutralizer would not be necessary.

To aid in dissolving the thickening agent in the ethyl formate, a substance which performs a co-solvent function must be added. The amount of co-solvent added can vary widely. At a minimum, because it functions as the primary solvent, co-solvent must be added in an amount sufficient to dissolve whatever compound is selected as the viscosity modifying thickening agent. In one preferred embodiment, the co-solvent is ethanol.

Quick evaporation of pure ethyl formate prevents it from having sufficient time to be effective on the target organisms living below the soil surface. To keep ethyl formate from evaporating too quickly, its partial vapor pressure must be lowered. The present invention accomplishes this by adding to the ethyl formate a suitable amount of a substance which functions as a dilution agent. In a preferred embodiment of the present invention, the dilution agent is ethanol.

In addition to reducing its vapor pressure/rate of evaporation, for ethyl formate to be effective as a soil fumigant the amount and rate of its decomposition must also be reduced. When contacted with water, ethyl formate normally decomposes according to the following equation:

$$\begin{matrix}\begin{matrix}{C}_{2} {H}_{5} OOCH \\ ( Ethyl Formate )\end{matrix} + \begin{matrix}{H}_{2} O \\ ( Water )\end{matrix} = & \begin{matrix}HCOOH \\ ( Formic Acid )\end{matrix} +\end{matrix} \begin{matrix}{C}_{2} {H}_{5} OH \\ ( Ethanol )\end{matrix}$$

This reaction is an equilibrium reaction, according to the equilibrium equation (where K is constant):

$$\frac{[ {C}_{2} {H}_{5} OH ] [ HCOOH ]}{[ {HCOOC}_{2} {H}_{5} ] [ {H}_{2} O ]} = K$$

The reaction is also auto-catalytic, i.e., the initial presence of some formic acid catalyzes the forward reaction.

In accordance with the reaction equilibrium noted above (and because K is constant at a given temperature), the presence of ethanol in the reaction mixture will deter and reduce the decomposition of ethyl formate into ethanol and formic acid. Moreover, as noted above, ethanol also serves as a preferred co-solvent, aiding in dissolving the viscosity modifying thickening agent. Thus, the preferred choice for the dilution agent is the alcohol used to make the ester, namely, ethanol. The amount of ethanol added is in the range of about 0 to about 50% by weight, preferably in the range of about 20 to about 40% by weight.

While in the preferred embodiment the same substance (ethanol) which serves as a co-solvent also functions as a dilution agent, the two need not necessarily be the one and the same. The co-solvent and the dilution agent may be two different compounds.

The SFMEF compositions of the present invention remain in contact with the soil for a longer time. The compositions' vapor is given off at a slower rate while retaining the fumigant properties exhibited by ethyl formate when it is used as a space/storage/commodity fumigant. The SFMEF of the present invention achieves an increased fumigation time, which increases the practical lethal dose effectiveness for soil pathogen nematodes and other pathogens.

The ethyl formate compositions of the present invention also have the quality of breaking down in time, by hydrolysis, to produce two naturally-occurring, environmentally-friendly substances which are readily found in nature and which are biodegradable: ethanol and formic acid. Thus, unlike most other fumigants, the SFMEF does not result in accumulative persistent pollutants. “Environmentally friendly” materials have a lesser or reduced effect on human health and the environment when compared with competing products or services that serve the same purpose, including materials which have significantly reduced toxicity to non-targeted plants and animals, especially humans. “Environmentally friendly” also encompasses biodegradable materials. Preferably, substances considered to be environmentally friendly are ones which are not recognized as hazardous to the health of humans or other organisms. Large scale environmental effects (such as the ozone layer, water table, and the like) from the production and use of environmentally friendly materials should also be insignificant.

Another significant benefit of the SFMEF compositions and methods of the present invention is that the degradation product formic acid has significant nematocidal properties in and of itself, and remains in the soil for some time before biodegrading. Consequently, the SFMEF of the present invention has been shown to be 100% effective in eliminating pathogens that may exist in their infection stages in the soil, as well as completely blocking nematodes and also completely blocking nematode production from eggs which have been laid deep in the soil.

The amount of SFMEF of the present invention to be applied to a field will vary widely depending upon a number of factors, which one skilled in the art would be capable of determining. By way of example only, in one embodiment of the present invention, an application dose of about 100-600 Kg/Hectare, preferably about 200-600 Kg/Hectare, may be used.

In one preferred method of the present invention, soil is fumigated by applying the SFMEF of the present invention, after which the soil is immediately covered with a virtually impermeable plastic sheet (in an open field situation). It may also be applied to potted or unpotted plants (in a greenhouse setting). A second solvent was added to the ethyl formate to completely dissolve the polymer.

### EXAMPLE 1

To examine the solubility of thixotropic polymer viscosity modifier, 0.1 g of Carbopol® 2623 was added to 100 g of ethyl formate. The polymer remained visible as a solid and did not dissolve.

### EXAMPLE 2

To improve the solubility of the polymer, 0.1 g of Carbopol® 2623 and 30 g ethanaol were added to 70 g of ethyl formate along with a few drops of neutralizing agent, triethylamine (to activate the polymer). The polymer dissolved.

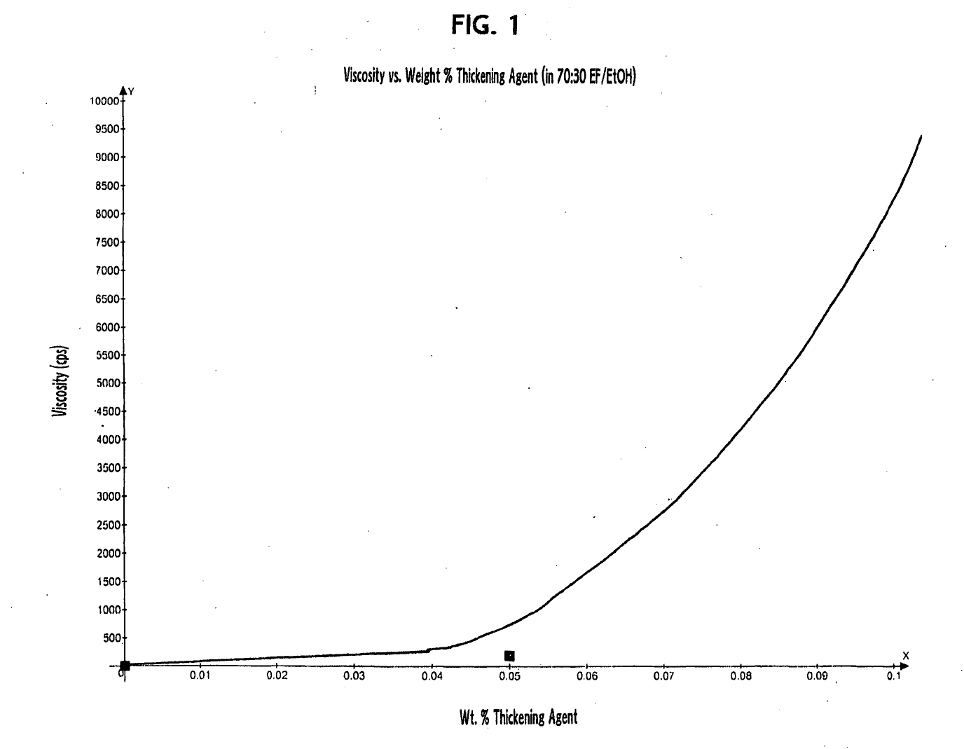

Examples 3-5 below illustrate the polymer that was used, and the fact that the addition of 0.05 thru 0.1% wt. of a suitable thickening agent (plus neutralizing agent) results in a significant increase in the viscosity of the modified ethyl formate mixture. See also FIG. 1.

### EXAMPLE 3

For a mixture of 70% by weight ethyl formate and 30% by weight ethanol only (no added thickening agent), the viscosity was determined at 20° C. using a Brookfield Viscometer to be 0.8 centipoise.

### EXAMPLE 4

For a mixture of 70% ethyl formate and 30% weight ethanol, 0.05% of Carbopol® 2623, plus a few drops of neutralizer (triethylamine) were added. The viscosity was determined at 20° C. to be 194 centipoise.

### EXAMPLE 5

For a mixture of 70% by weight ethyl formate and 30% by weight ethanol, 0.10% by weight of Carbopol® 2623, plus neutralizer was added. The viscosity was determined at 20° C. to be 9456 centipoise.

To see if the SFMEF of the present invention retained its effectiveness in organism elimination of nematodes, a number of bioassays were carried out. An in vitro test was carried out using five Siracuse Glasses per test. In each glass, a solution of the liquid under test was poured; and 20 μl of the nematode suspension containing 50 nematodes was added. Because five Siracuse Glasses were used per test, each treatment was replicated five times.

Numbers of live and paralyzed nematodes were counted under a binocular microscope after incubation times for 24 hours. Nematodes were considered dead if they gave no response to physical stimuli such as mechanical stirring, pricking with the point of a needle, etc. Toxicity was estimated according to the mean percentage of nematodes surviving after 24 hours. The limits of each concentration, and the surviving nematodes, were determined. Nematodes in distilled water and furadan served as controls.

The reversible effect of the toxicity was estimated after transfer of paralyzed juveniles in fresh water and determination of percentage of dead nematodes after 24 hours, then 72 or 96 hours. Delayed toxicity was estimated according to the following method: the nematodes whose mobility was not yet inhibited after different incubation times in test solutions were collected and dipped in fresh water. The proportion of dead nematodes was estimated after 72 hours in water.

### EXAMPLE 6

In this test, pure ethyl formate was used. The results were:

$$\frac{Biological Group}{Nacobbus aberrans} \qquad \frac{Origin}{Tomato} \qquad \frac{Toxicity Expressed ( \% Survival )}{0 \%}$$

After 96 hours no recovery was seen for these nematodes in water.

Examples 7-12 illustrate how the SFMEF of the present invention retains its effectiveness in the destruction of nematodes and nematode eggs in a standard bioassay procedure.

### EXAMPLE 7

In this test, a solution of 29.9% by weight ethanol and 70% by weight ethyl formate with 0.05% weight Carbopol® 2623 plus neutralizer (0.05% weight) was used. The results were:

$$\frac{Biological Group}{Nacobbus aberrans} \qquad \frac{Origin}{Tomato} \qquad \frac{Toxicity Expressed ( \% Survival )}{0 \%}$$

After 96 hours no recovery was seen for these nematodes in water.

### EXAMPLE 8

In this test, a solution of 30% by weight ethanol and 70% by weight water was used. The results were:

$$\frac{Biological Group}{Nacobbus aberrans} \qquad \frac{Origin}{Tomato} \qquad \frac{Toxicity Expressed ( \% Survival )}{\begin{matrix}No apparent movement \\ after 24 hours\end{matrix} }$$

After 96 hours, 1% of these nematodes recovered in water.

### EXAMPLE 9

In this test, a test solution of carbofuran (Furadan®), a non-fumigant nematicide, was used. Carbofuran, also known as 2,3-dihydro-2,2-dimethyl-7-benzofuranyl methylcarbamate, is one of the most toxic carbamate pesticides. It is manufactured by reaction of methyl isocyanate with 2,3-dihydro-2,2-dimethyl-7-hydroxybenzofuran, and is used to control insects in a wide variety of field crops, including potatoes, corn and soybeans. It is a systemic insecticide, which means that the plant absorbs it through the roots, and from here the plant distributes it throughout its organs (mainly vessels, stems and leaves; not the fruits), where insecticidal concentrations are attained. Carbofuran also has contact activity against pests. It has one of the highest acute toxicities to humans of any insecticide widely used on field crops. A quarter teaspoon (1 ml) can be fatal.

The results using Furadan® were:

$$\frac{Biological Group}{Nacobbus aberrans} \qquad \frac{Origin}{Tomato} \qquad \frac{Toxicity Expressed ( \% Survival )}{0 \%}$$

After 96 hours no recovery was seen for these nematodes in water.

### EXAMPLE 10

In this test, a test solution of water was used. The results were:

$$\frac{Biological Group}{Nacobbus aberrans} \qquad \frac{Origin}{Tomato} \qquad \frac{Toxicity Expressed ( \% Survival )}{239 / 334 = 71.6 \%}$$

### EXAMPLE 11

In this series of tests, nematode eggs were tested with the same solution as the nematodes. 715 eggs/mass×2=2145 eggs/siracuse cup. The test time was 24 hours, followed by 72 hours in water. The results were:

| Solvent | % Eclosion |
|---|---|
| Water | 47.4 |
| Furadan | 0.05 |
| Ethanol | 2.16 |
| Ethanol + Polymer | 0.37 |
| Ethyl Formate | 0.05 |
| Ethyl Formate + Ethanol | 0 |
| Ethyl Formate + Ethanol + Polymer | 0 |

As a final test, the length of time the SFMEF of the present invention would remain (a) in an uncovered soil and (b) in a soil covered by impermeable plastic was examined.

### EXAMPLE 12

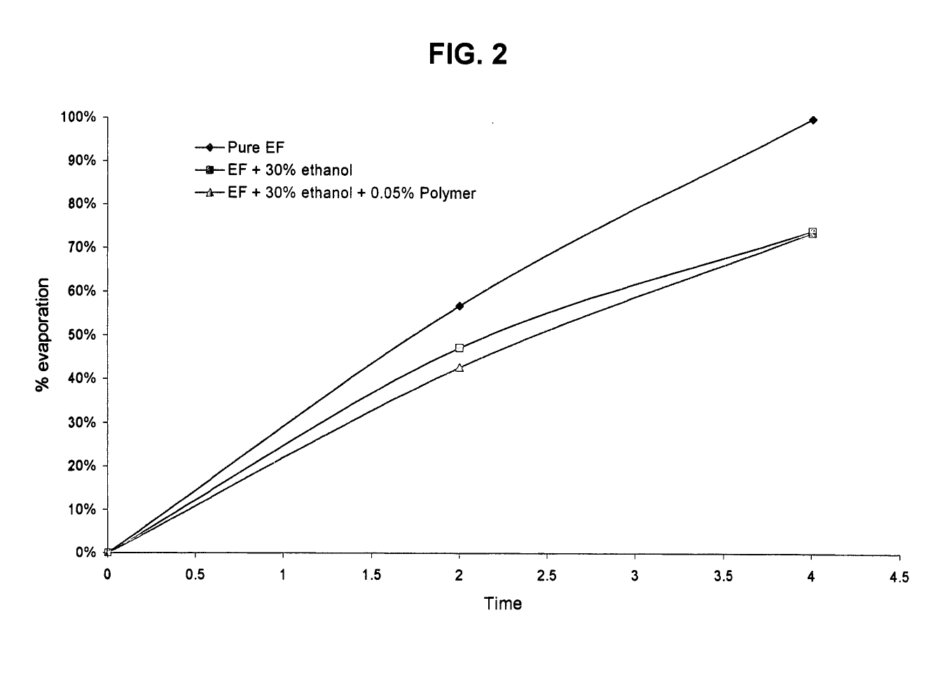

Field tests were conducted confirming that the addition of ethanol and thickening agent. The results shown in FIG. 2 illustrate the relative evaporation rates of three samples. To reduce evaporation rates in a field application even further (i.e., for five or six days), it is preferred that additional measures be taken such as covering the treated soil with an impermeable plastic layer immediately after application of the fumigant.

Examples 13 and 14 illustrate how ethyl formate loss by vaporization from soil can be further reduced by the addition of the dilution agent and polymer and covering with a virtually impermeable plastic sheet.

### EXAMPLE 13

In this example, as shown in Table 1 below, samples of the SFMEF of the present invention were sprayed onto soil in a glass container and the container was covered with impermeable plastic. The samples' average evaporation loss was less than 2% per day.

TABLE 1

| | Days | | | | | | |
|---|---|---|---|---|---|---|---|
| | 0 | 1 | 2 | 3 | 4 | 5 | Evaporation per day |
| Liquid lost (g) | 0 | 2.0 | 3.4 | 4.1 | 4.5 | 4.7 | 3.1% |
| Liquid lost (g)/day | 0 | 2.0 | 1.4 | 0.7 | 0.4 | 0.2 | 0.9% |

While the present invention has been described with particular reference to the drawings, it should be understood that various modifications could be made without departing from the spirit and scope of the present invention. It is also to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. Further, throughout the instant disclosure, it will be appreciated that several terms may be used interchangeably with one another.

If not otherwise stated herein, it may be assumed that all components and/or processes described heretofore may, if appropriate, be considered to be interchangeable with similar components and/or processes disclosed elsewhere in the specification, unless an express indication is made to the contrary.

It should be appreciated that the compositions and methods of the present invention may be formulated and conducted as appropriate for any context at hand. The embodiments described above are to be considered in all respects only as illustrative and not restrictive. All changes which come within the meaning and range of equivalency of the claims are to be embraced within their scope.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the descriptions herein are proffered by way of example only to facilitate comprehension of the invention and should not be construed to limit the scope thereof.

Furthermore, although specific embodiments of the present invention have been described herein, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention.

The present invention has been described in considerable detail in order to comply with the patent laws by providing full public disclosure of at least one of its forms. However, such detailed description is not intended in any way to limit the broad features or principles of the present invention, or the scope of the patent to be granted.

What is claimed is:

1. An ethyl formate composition comprising ethyl formate, a thickening agent and a co-solvent.

2. The composition of claim 1, wherein said co-solvent is ethanol.

3. The composition of claim 1, wherein said thickening agent is viscosity modifying.

4. The composition of claim 3, wherein said viscosity modifying thickening agent is a thixotropic polymer.

5. The composition of claim 1, further comprising a dilution agent.

6. The composition of claim 5, wherein said dilution agent is ethanol.

7. The composition of claim 1, wherein said composition has a viscosity of between about 1 and about 500 centipoise.

8. The composition of claim 1, wherein said composition is a soil fumigant.

9. The composition of claim 1, wherein upon degradation said soil fumigant decomposes into environmentally friendly components.

10. A soil fumigant comprising an ethyl formate formulation having a viscosity between about 1 and about 500 centipoise.

11. The soil fumigant of claim 10, wherein said formulation comprises ethyl formate, a thickening agent and ethanol.

12. The soil fumigant of claim 11, wherein said thickening agent is a viscosity modifying polymer.

13. The composition of claim 12, wherein upon degradation said soil fumigant decomposes into environmentally friendly components.

14. A method of controlling deleterious sub-surface organisms comprising applying to soil an effective amount of a formulation comprising ethyl formate, a viscosity modifying thickening agent and a co-solvent.

15. The method of claim 14, wherein said co-solvent is ethanol.

16. The method of claim 14, further comprising a dilution agent.

17. The method of claim 14, wherein said formulation has a viscosity of between about 1 to about 500 centipoise.

18. The method of claim 14, wherein said organisms are nematodes.

19. The method of claim 14, wherein said formulation degrades into environmentally friendly components.

20. A method for the control of a nematode which comprises applying a fumigant preparation comprising ethyl formate, a viscosity modifying thickening agent and ethanol.

21. The method of claim 20, wherein said fumigant preparation is applied on a soil surface.

22. The method of claim 21, wherein said fumigant preparation is applied to said soil prior to the planting of a crop to reduce damage to said crop by said nematode.

23. The method of claim 22, wherein said viscosity modifying thickening agent is a thixotropic polymer.

24. The method of claim 22, wherein said crop is selected from the group consisting of strawberries, tomatoes and peppers.

25. The method of claim 22, wherein said fumigant preparation decomposes into environmentally friendly components.

26. A method of soil fumigation comprising applying to the soil an effective amount of a composition comprising ethyl formate, a viscosity modifying thickening agent and ethanol, said composition having a viscosity between about 1 and about 500 centipoise.

27. The method of claim 26, wherein said composition decomposes into environmentally friendly components.
